(19) United States
(12) Patent Application Publication
(10) Pub. No.: US 2010/0151216 A1
(43) Pub. Date: Jun. 17, 2010

(54) Stratified panel structure possessing interleaved, thin-high-density, thick-low-density core-structure stack arrangement

(75) Inventors: Russell A. Monk, Salem, OR (US); Lance A. Hicks, Salem, OR (US)

Correspondence Address: ROBERT D. VARITZ, P.C., 4915 SE 33RD PLACE, PORTLAND, OR, 97202, US

(73) Assignee: High Impact Technology, L.L.C.

(21) Appl. No.: 12/658,991

(22) Filed: Feb. 17, 2010

Related U.S. Application Data
(62) Division of application No. 12/006,487, filed on Jan. 2, 2008.
(60) Provisional application No. 60/879,509, filed on Jan. 8, 2007.

(51) Int. Cl. B32B 7/02

(52) U.S. Cl. 428/213

(57) ABSTRACT

A generally planar composite panel structure including (a) a stratified, generally planar main body core having perimetral edges, and spaced, generally planar, outwardly facing facial expanses extending substantially to such edges, and (b) in a stacked arrangement within the core, intermediate the mentioned facial expanses, at least one high-density, generally planar, fibre-reinforced layer structure bracketed by a pair of low-density, generally planar layer structures, each of which layer structures extends substantially to the core's perimetral edges.

### CROSS REFERENCE TO RELATED APPLICATIONS

This application is a continuation of currently co-pending, parent U.S. patent application Ser. No. 12/006,487, filed Jan. 2, 2008 for “Formed Panel Structure”, which parent application claims priority to U.S. Provisional Patent Application Ser. No. 60/879,509, filed Jan. 8, 2007, for “Panel Structure with Screw-Thread-Binding Core Feature”. The entire disclosure contents of these two prior-filed applications are hereby incorporated herein by reference.

### BACKGROUND AND SUMMARY OF INVENTION

This invention pertains to panel structure, and in particular to lightweight, composite, panel structure specially designed to accommodate robust screw-thread attachment to it, and referred to herein as a stratified panel structure possessing an interleaved, thin-high-density, thick-low-density core-structure stack arrangement.

Composite panel structures of many varieties exist for use in a large field of applications. In these applications, panel compositing plays an important role in pointedly enhancing certain differing-function panel features which are associated with particular use requirements. For example, in many applications, it is important that an employed panel structure be as light in weight as possible without such lightweightness significantly compromising depth- or thickness-dependent configurational stiffness and stability. In this context, a typical composite panel structure will take the form of a layered structure wherein a thin, high-density facial cladding bondedly brackets a low-density core.

In situations regarding such a composite panel structure where an additional structural consideration involves accommodating screw-thread-based attachments to the panel structure, there is conflict between the important issues of maintaining maximum panel lightweightness, while at the same time assuring that the panel's internal core structure will offer stable binding for the threads in a screw. In general terms, this consideration becomes challenging because of the fact that lightweight core materials typically provide a less-than-ideal screw-thread binding (anchoring) environment.

Additionally, and with respect to the mentioned screw-thread binding issue, it may be desirable that a composite panel structure be configured so that robust screw attachment can occur essentially everywhere over the panel structure's surface-area expanse.

Finally, it may be important that all of the above considerations be taken into account not only with respect to a composite panel structure which, while certainly being formable with specially shaped topographic curvatures, as desired, nevertheless in all instances possesses an overall, generally planar (substantially uniform thickness) configuration.

The present invention proposes a composite panel structure which uniquely addresses all of the above matters. This structure includes a main body having perimetral (perimeter) edges, and a pair of spaced, outwardly facing facial expanses that extend to the edges. The core of the main body is a layered/stratified structure formed principally, i.e., in a volumetric sense, by at least one (though preferably two or more) spaced pair(s) of relatively thick low-density layers which, in relation to each such pair, are bonded to the opposite faces of a thus bracketed, relatively thin, fibre-reinforced, high-density layer.

The low-density layers are preferably formed of PET (polyethylene terephthalate) material, and each bracketed high-density layer is formed preferably of a fibre-reinforced, resin-based material, such as the commercially available material sold under the trademark Polystrand®, produced by Polystrand, Inc. in Montrose, Colo. Both of these kinds of materials support an additional preference which is that the overall composite panel structure be made of thermoformable material.

Preferably, also, both of the outwardly-facing facial expanses of the main body are clad by thin, bonded, fibre-reinforced, resin-based material which is like that employed in each bracketed layer.

In all embodiments of the invention, the high-density bracketed layers in the main body extend substantially completely to the body's perimetral edges.

In this proposed composite panel structure, adequate trans-panel depth, or thickness, and thus dimensional stability, are assured by the presence in the main body, or core, of plural, suitably thick, low-density layers. Overall lightweightness in this panel structure is assured by the fact that, given a sufficient low-density/high-density differential between the two types of main-body-included, stratifed layer materials, the low-density material is intentionally the principal contributor to the panel structure's overall volume.

Robust binding of an attached screw is assured by the panel-internal presence of the mentioned, high-density bracketed layer structure. This high-density, stratified layer structure effectively mimics the kind of screw-thread binding that one might expect from a panel structure possessing a higher overall main body density, notwithstanding the fact that the actual main body is predominantly formed of lightweight, low-density material. Where two or more thin, spaced, high-density, body-internal core layers are included, the sturdy binding “mimicking” just mentioned is even more noticeably presented.

The ability of the proposed panel structure to accommodate stabilized, robust screw attachment and binding at substantially every location distributed over the broad surface area of the structure is contributed by the fact that the main-body-internal high-density core layer structure is coextensive with substantially the full broad expanse of the panel structure.

These and other features of the invention will become more fully apparent as it's detailed description which follows below is read in conjunction with the accompanying drawings.

### DESCRIPTION OF THE DRAWINGS

FIG. 1 is a fragmentary isometric view of a corner of a substantially planar, thermoformed, composite panel structure, or panel, made in accordance with a preferred and best-mode embodiment of the present invention. This figure also shows a screw which is about to be attached to (driven into) the panel structure at a freely chosen, non-pre-established location therein.

FIG. 2 is a fragmentary cross-sectional detail of the panel structure shown in FIG. 1 picturing a condition wherein the unattached screw shown in FIG. 1 has been driven fully into that structure.

FIGS. 3 and 4 illustrate two different modifications of the panel structure appearing in FIGS. 1 and 2.

### DETAILED DESCRIPTION OF THE INVENTION

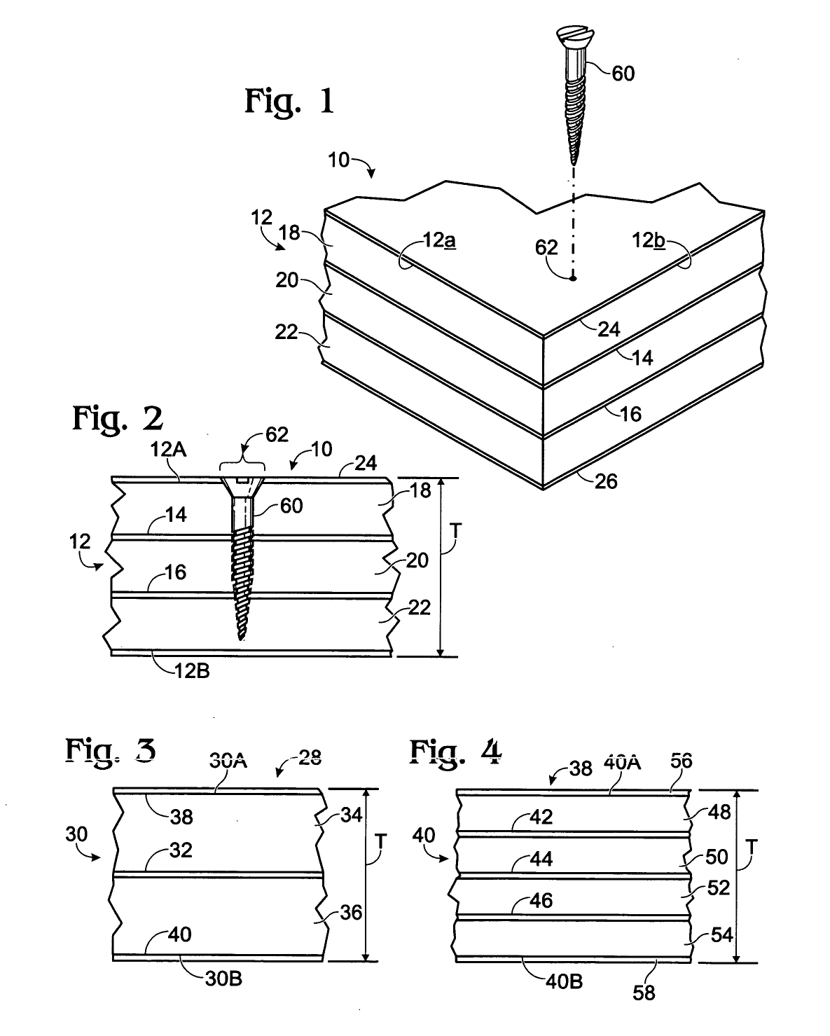

Turning attention to FIGS. 1 and 2, indicated generally and fragmentarily at 10 is a composite panel structure, or panel, which has been made in accordance with a preferred and best-mode embodiment of the present invention. Included in panel 10 is a main body core 12 having perimetral edges, two of which are shown at 12a and 12b in FIG. 1, and a pair of outwardly-facing, broad facial expanses shown at 12A, 12B in FIG. 2. Panel 10, as shown and described for illustration purposes herein, is generally planar, is generally rectangular in perimetral outline, and has an overall thickness T (see FIG. 2) of about ⅝-inches. None of these just-mentioned shape and size features is in any way critical to the invention. In other words, panels having different, selectable lateral and thickness dimensions, and different characteristics of non-planarity, may be made and employed in accordance with the invention.

Main body core 12, as seen in FIGS. 1 and 2, is formed as a layered, stratified core possessing two, included, generally planar and spaced, relatively thin, high-density fibre-reinforced, stacked layer structures, or layers, 14, 16 sandwiched between, or bracketed by, different pairs of three, noticeably thicker, low-density layer structures, or layers, 18, 20, 22. All five of these several layers extend substantially to the overall panel core-body's perimetral edges. Core 12 is also referred to herein as an interleaved, alternating, thin-high-density, thick-low-density core-structure stack arrangement.

Bonded to core-body facial expanses 12A, 12B are two generally planar, high-density, relatively thin, fibre-reinforced cladding sheets 24, 26, respectively, which also extend substantially to the panel core-body's perimetral edges. The material used to form these two cladding sheets herein, shortly to be described, is the same as the material used to form bracketed layers 14, 16.

In panel 10, layers 18, 20, 22 are preferably formed of thermoformable PET (polyethylene terephthalate) foam material having a density of about 6-lbs/ft³. Each of these PET layers has a thickness of about 0.155-inches.

Layers 14, 16, 24, 26 are preferably formed of two, 0.020-inch thickness sub-layers of the fibre-reinforced, polymeric thermoformable material sold under the trademark Polystrand®, made by Polystrand, Inc. in Montrose, Colo. This Polystrand® material has a density of about 120-lbs/ft³.

The entirety of panel 10 has been consolidated as a single unit through thermal bonding under suitable applied pressure—a conventional thermoforming practice. In the finished panel, as so far described herein, the PET layer material furnishes most of the volume of the panel as a whole, and occupies/accounts for about 75% of the panel's volume.

While we have determined that, in most instances, a composite panel structure constructed and organized in the manner shown and described for panel 10 constitutes a preferred and best-mode embodiment of the invention, we recognize that various useful modified forms of the invention may be created and employed for use in certain settings. Two such modified forms are shown in FIGS. 3 and 4.

Seen in FIG. 3 is a composite, planar panel structure 28 possessing a stratified, main body core 30 which includes but a single internal, thin, high-density layer 32 bracketed by two, low-density, thicker layers 34, 36. Thin, high-density cladding sheets 38, 40 are bonded thermally to the outwardly facing facial expanses 30A, 30B, respectively, in core 30. For the purpose of illustration herein, panel structure 28 has the same dimensioning as does previously described panel structure 10.

The material making up layer 32 and cladding sheets 38, 40 is the same as the material employed in earlier-discussed layers and cladding sheets 14, 16, 24, 26. The material used in body layers 34, 36 is the same as the material used in previously mentioned layers 18, 20, 22.

In FIG. 4 there is illustrated at 38 a planar composite panel structure having a stratified, main body core 40 which possesses outwardly facing facial expanses 40A, 40B. Core 40 includes three, thin, high-density, internal layers 42, 44, 46 which are respectively bracketed within the core body by different pairs of low-density layers 48, 50, 52, 54. Thin, high-density cladding sheets 56, 58 are thermally bonded to facial expanses 40A, 40B, respectively.

The material making up layers 42, 44, 46 and cladding sheets 56, 58 is the same as the material employed in layers and cladding sheets 14, 16, 24, 26. The material employed in main-body layers 48, 50, 52, 54 is the same as the material used in layers 18, 20, 22.

All herein illustrated versions of the composite, stratified-core panel structure of this invention function in substantially the same way. Overall desired lightweightness is contributed, and assured, by the dominant volumetric presence of the low-density main body core layers. Significant load-bearing capability, as a panel per se, is furnished by the outside-surface, high-density, fibre-reinforced cladding sheets, and by the main-body-core-internal, high-density, fibre-reinforced layers. Tenacious and robust screw-thread binding and securing is established by the presence of one or more of the disclosed core-included high-density layers, notwithstanding the fact that most of the length of a threaded screw shank is engaged only by the low-density layer material in the main body core of a panel.

With specific regard to screw attachment, FIG. 1 shows a screw 60 which is about to be driven into panel 10 at a freely chosen, non-pre-dedicated panel location 62. Full attachment of this screw at that location is pictured in FIG. 2. These two drawing figures illustrate another important feature of the invention which results from the main-body-core-internal high-density layers being substantially coextensive with the full breadth of panel 10, i.e., extending substantially fully to the perimetral edges of the panel. With this structural condition in place, secure screw attachment to the panel can be created at substantially any and every location over the full expanse of the panel.

Something else to note with regard to screw attachment, it is entirely possible to employ the tenacity, screw-thread-binding features of the panel structure of the invention in relation to edge-angular screw attachments performed at the edges of a panel. This is especially evident if one thinks about appropriately beveling the edge of a panel structure of the invention, such as at a 45-degree angle, to accommodate desired, angular screw attachment.

Accordingly, a uniquely formed, stratified-core panel structure has been illustrated and described herein, offered by the present invention, which, for the reasons elaborated above, offers a special form of lightweight panel which nonetheless presents an opportunity for robust, “all-over”, secure screw-thread binding screw attachability. Variations and modifications may certainly be made which will come within the spirit and scope of the invention.

We claim:

1. A stratified, composite panel structure possessing a layer-interleaved, thin high-density, thick low-density stack arrangement comprising
a stratified, main body core having perimetral edges, and spaced, generally planar, outwardly facing facial expanses extending substantially to said edges, and
within said core, intermediate said facial expanses, at least one high-density, generally planar, fibre-reinforced layer structure bracketed by a pair of low-density, generally planar layer structures, each of said layer structures extending substantially to said edges.

2. The structure of claim 1, wherein said main body core has a defined volume, and said fibre-reinforced layer structure occupies a smaller amount of said volume than do said low-density layer structures.

3. The structure of claim 2 which further comprises at least one high-density, generally planar, fibre-reinforced cladding sheet bonded to, and substantially coextensive with, one of said facial expanses.

4. The structure of claim 1 which further comprises, within said main body core, intermediate said facial expanses, and bracketed by a pair of low-density layer structures, at least a second, high-density, generally planar, fibre-reinforced layer structure which is spaced from said first-mentioned fibre-reinforced layer structure, and which extends substantially to said edges.

5. The structure of claim 1, wherein said high-density layer structure and said low-density layer structures are formed of thermoformable materials.
